(19) United States
(12) Patent Application Publication
(10) Pub. No.: US 2013/0286463 A1
(43) Pub. Date: Oct. 31, 2013

(54) DYNAMIC ACTUATION WAVEFORM FOR A DIGITAL MICROMIRROR DEVICE

(71) Applicant: Texas Instruments Incorporated, Dallas, TX (US)

(72) Inventors: Lance W. Barron, Wylie, TX (US); William C. McDonald, Allen, TX (US)

(21) Appl. No.: 13/659,506

(22) Filed: Oct. 24, 2012

Related U.S. Application Data
(60) Provisional application No. 61/550,739, filed on Oct. 24, 2011.

(51) Int. Cl. G02B 26/08

(52) U.S. Cl. CPC G02B 26/0841
USPC 359/295

(57) ABSTRACT

A method of actuating micromirror elements of a digital micromirror device is disclosed. A logic state is stored in the micromirror element including applying a negative voltage more negative than about −5 volts to the micromirror element, applying a positive voltage less than about 5 volts to a first electrode, and applying ground to a second electrode. A first logic state is switched to a second logic state with an inverted waveform, including applying ground to the first electrode, applying a positive voltage less than 5 volts to the second electrode, applying a negative BSA voltage to the first electrode, applying a positive reset voltage pulse greater than about 10 volts, removing the negative BSA voltage, and applying the negative voltage to the micromirror element.

This application claims the benefit of Provisional Application No. 61/550,739, filed Oct. 24, 2011, the entirety of which is hereby incorporated by reference.

### BACKGROUND

This relates generally to the field of micromirror devices; and, more particularly, to a method for resetting the mirror elements of such devices.

Microelectromechanical system (MEMS) devices that employ micromirrors, such as DLP™ digital micromirror devices (DMDs) available from Texas Instruments, are used in motion picture theatre projectors, portable projectors, television sets, and in many other applications. The DMD is an array of thousands of tiny tilting mirrors. Light incident on the DMD is selectivity reflected from each mirror toward or away from an image plane, to form images. To permit the mirrors to tilt, each mirror is attached to a torsion bar.

An example micromirror 20 from a DMD array is illustrated in FIG. 1. The DMD mirror 32 is formed on a torsion bar 26 which is held in place by pedestals 22 and 34. Depending upon voltages applied to the mirror 32 and to electrodes 28 and 36 the micromirror 32 may tilt to the left coming close to or in contact with landing pad 30 or may tilt to the right coming close to or in contact with landing pad 38.

A micromirror in close proximity or in contact with a landing pad may stick to the landing pad even when the voltages have been removed from the electrodes and the mirror. For a given sticking force at the landing surface, it is possible to define a hinge restoration force that will free the mirrors from a landed state (reset). However, due to other system considerations, such as the desire to operate the DMD at relatively low voltages, it may not be practical to increase the hinge stiffness to a point where all mirrors will reset automatically upon removal on the address signal. Thus, to encourage the mirrors to reset without an unduly large hinge stiffness, a bias signal with an extra reset voltage has been applied to the address electrodes. See, for example, U.S. Pat. Nos. 5,096,279 and 5,768,007, incorporated herein by reference.

The voltage required to tilt the micromirror or to reset the micromirror depends upon a number of factors, such as the flexibility of the torsion bar 26, the weight and size of the micromirror 32, and the distance between the electrodes 28 and 36 and the micromirror 32. As dimension are scaled down and the micromirror gets smaller, the length of the micromirror lever arm from the torsion bar 26 to the electrodes 28 or 36 is reduced and may require more force to switch the micromirror. This may require higher voltages to be applied to the electrodes to switch the micromirror and may impose changes to the manufacturing flow to accommodate the increased voltages which may be costly.

### SUMMARY

Disclosed embodiments relate to a method of operating an integrated circuit with a micromirror using an inverted waveform. A described example relates to a method of operating an integrated circuit with a micromirror using a HV inverted waveform.

In a described example, a method of operating an integrated circuit containing a micromirror comprises storing a logic state in the micromirror including applying a negative voltage more negative than about −5 volts to the micromirror, applying a positive voltage less than about 5 volts to a first electrode, and applying ground to a second electrode; and switching from a first logic state to a second logic state with a true inverted waveform including applying ground to the first electrode, applying a positive voltage less than 5 volts to the second electrode, applying a negative BSA voltage to the first electrode, applying a positive reset voltage pulse greater than about 10 volts, removing the negative BSA voltage, and applying the negative voltage to the micromirror.

The first electrode may be coupled to a first SRAM cell in an SRAM array and the second electrode may be coupled to a second SRAM cell in the SRAM array. The SRAM array may be formed in an isolated p-type well. During the step of storing a logic state, the negative voltage to the micromirror may be in the range of −6 to −10 volts and the positive voltage to the first electrode may be in the range of 1 to 5 volts. In one example, the negative voltage may be approximately −8.2 volts and the positive voltage may be approximately 1.8 volts. During the step of switching, the positive voltage to the second electrode may be in the range of 1 to 5 volts, the negative BSA voltage may be in the range of −1 to −5 volts, the positive reset voltage may be in the range of 10 to 25 volts and the negative voltage to the micromirror may be in the range of −6 to −10 volts. In one example, the positive voltage to the second electrode may be approximately 1.8 volts, the negative BSA voltage may be about −3.2 volts, the positive reset voltage may be approximately 11.8 volts and the negative voltage to the micromirror may be approximately −8.2 volts. In some cases, the voltages which may be more negative than about 5 volts and more positive than about 5 volts are switched with drain extended CMOS transistors.

A described example of a method of operating an integrated circuit containing a micromirror comprises: storing a logic state in the micromirror including applying a negative voltage more negative than about −5 volts to the micromirror, applying a positive voltage less than about 5 volts to a first electrode, and applying ground to a second electrode; and switching from a first logic state to a second logic state with a HV inverted waveform including applying ground to the first electrode, applying a positive voltage less than 5 volts to the second electrode, applying an additional positive BSA voltage to the second electrode, applying a positive reset voltage pulse greater than about 10 volts, removing the additional positive BSA voltage, and applying the negative voltage to the micromirror.

The first electrode may be coupled to a first SRAM cell in an SRAM array and the second electrode may be coupled to a second SRAM cell in the SRAM array. During the step of storing a logic state, the negative voltage to the micromirror may be in the range of −6 to −10 volts and the positive voltage to the first electrode may be in the range of 1 to 5 volts. In some cases, the negative voltage may be approximately −8.2 volts and the positive voltage may be approximately 1.8 volts. During the step of switching, the positive voltage to the second electrode may be in the range of 1 to 5 volts, the positive BSA voltage may be in the range of 1 to 5 volts, the positive reset voltage may be in the range of 10 to 25 volts and the negative voltage to the micromirror may be in the range of −6 to −10 volts. In specific cases, the positive voltage to the second electrode may be approximately 1.8 volts, the positive BSA voltage may be about +3.2 volts, the positive reset voltage may be approximately 15 volts and the negative voltage to the micromirror may be approximately −8.2 volts. In cases, the voltages more negative than about 5 volts and more positive than about 5 volts may be switched with drain extended CMOS transistors.

### BRIEF DESCRIPTION OF THE DRAWINGS

Example embodiments are described with reference to accompanying drawings, wherein:

FIG. 1 (Prior Art) illustrates an existing micromirror.

FIG. 2A (Prior Art) illustrates a conventional voltage timing diagram for switching logic states of a micromirror.

FIGS. 2B and 2C (Prior Art) illustrate micromirror logic states “0” and “1”.

FIG. 3A illustrates an example voltage timing diagram for an embodiment formed according to principles of the invention.

FIG. 3B illustrates a micromirror coupled to an SRAM array formed according to principles of the invention.

FIG. 4A illustrates a voltage timing diagram for an embodiment formed according to principles of the invention.

FIG. 4B illustrates a micromirror coupled to an SRAM array formed according to principles of the invention

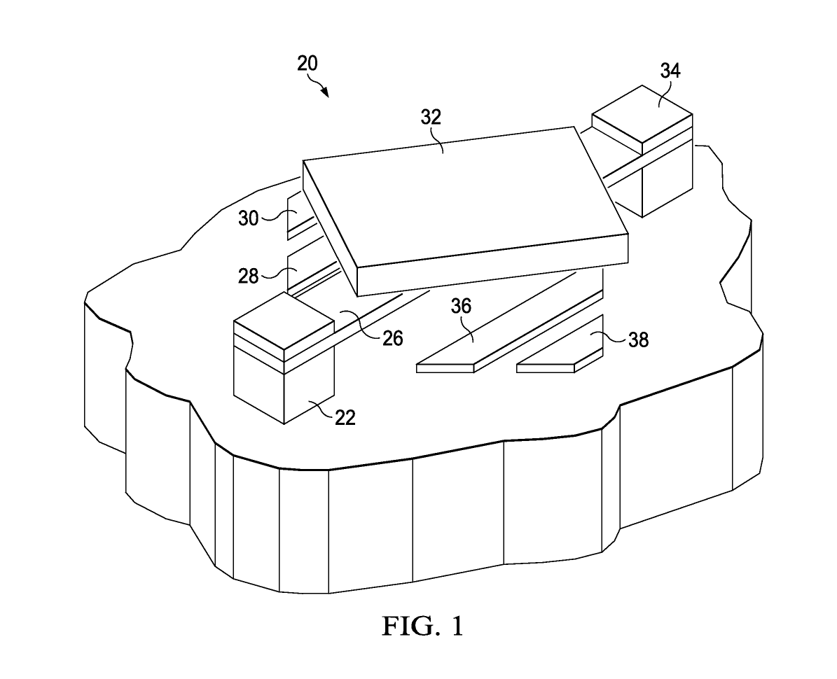

### DETAILED DESCRIPTION OF EXAMPLE EMBODIMENTS

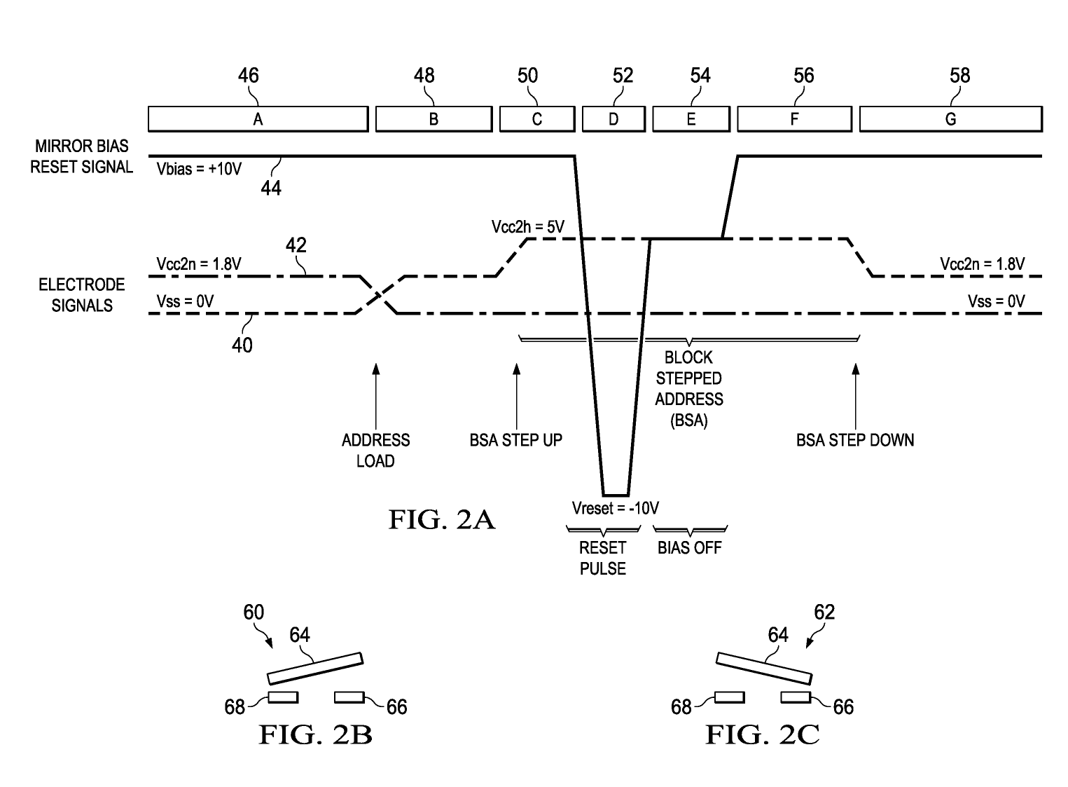

For illustrative purposes logic state “0” (60) is defined when a micromirror 64 is tilted left with its tip close to electrode 68 as in FIG. 2B, and logic state “1” (62) is defined when the micromirror 64 is tilted right with its tip close to electrode 66 as in FIG. 2C.

A conventional voltage timing diagram for switching a micromirror from a “0” state to a “1” state is shown in FIG. 2. Seven steps, 46 (A) through 58 (G), in the timing diagram switch the micromirror from a “0” state 60 to a “1” state 62. The voltages applied to the micromirror 64, the left electrode 68 and the right electrode 66 for each of the seven states are given in Table 1 in rows 1, 4, 7, 11, 14, 17, and 21 respectively. The voltage on the micromirror 64 is given in column 4, the voltage on the left electrode 68 is given in column 5 and the voltage on the right electrode 66 is given in column 6. The difference between the voltage on the micromirror 64 and the left electrode 68 is given in column 7 and the difference between the voltage on the micromirror 64 and the right electrode 66 is given in column 8.

Step A 46, the first step in a conventional voltage timing diagram is logic state “0” with +10 volts (R1, C4 where R=row and C=column) on the micromirror 64, 0 volts (R1, C5) on the left electrode 2028 and 1.8 volts (R1, C6) on the right electrode 66. The voltage difference of 10 volts (R1, C7) between the micromirror 64 and the left electrode 68 is larger than the voltage difference of 8.2 volts (R1, C8) between the micromirror 64 and the right electrode 66 and holds the micromirror in the “0” state.

Step B 48, the second step in a conventional voltage timing diagram loads the voltages for the new logic state “1”. As shown in the timing diagram and in Table 1, the voltage on the left electrode 68 is switched from 0 volts to 1.8 volts (R4, C5) and the voltage on the right electrode 66 is switched from 1.8 volts to 0 volts (R4, C6). Because of the sticking force between the micromirror 64 and the electrode 68 this change in voltage may be insufficient to switch the micromirror 64 from a “0” to a “1”.

In step C, 50, a block step address (BSA) voltage is applied to raise the left electrode 68 voltage from 1.8 volts to 5 volts (R7, C5). This reduces the voltage between micromirror 64 and the left electrode 68 from 8.2 volts (R4, C7) to 5 volts (R7, C7) which assists in the micro-mirror 64 switching, but may be insufficient to unstick all the micromirrors 64 from the electrode 68 across a large micromirror array.

In step D, 52, a reset pulse of −10 volts (R10, C4) is applied to the micromirror 64. This produces a difference voltage of −15 volts (R10, C7) between the micromirror 64 and the left electrode 68. This reset pulse 52 is of short duration. It is sufficiently long to unstick all the mirrors in the array but is shorter than the time constant required to switch a micromirror 64 from one logic state to another.

In step E, 54, the reset pulse is turned off and 5 volts (R10, C5) is applied to the micromirror forming a difference voltage of 0 volts (R13, C7) between the right electrode 66 and the micromirror 64, and a difference voltage of 5 volts (R13, C8) between the micromirror 64 and right electrode 66. Since the micromirror 64 is now in an unstuck state, and the voltage difference (5 volts) between the right electrode 66 and the micromirror 64 is larger than between the left electrode 68 and the micromirror 64, the micromirror begins to tilt toward the “1” state. (If a state “0” is loaded in step B, 48, the voltage between the left electrode 68 and the micromirror 64 would be larger and the micromirror would tilt toward the “0” state in step E, 54.)

The voltage on the micromirror is returned to 10 volts (R16, C4) in step F, 56. This increases the difference voltage between the micromirror 64 and the right electrode 66 from 5 volts (R13, C8) to 10 volts (R16, C8) and the voltage difference between the micromirror 64 and the left electrode 68 from 0 volts (R13, C7) to 5 volts (R16, C7).

In Step G, 58, the BSA voltage is turned off which changes the voltage on the left electrode from 5 volts (R13, C5) to 1.8 volts (R19, C5). The micromirror 64 is now in a logic state “1” with the micromirror tilted towards the right electrode 66. Note that the voltages are the same as in step A, 46 with the voltages on the electrodes 66 and 68 reversed.

In the above conventional voltage timing diagram, the micromirror voltage may switch from +10 volts (R1, C4) to −10 volts (R10, C4). In a typical CMOS process flow the negative voltage reliability limit may be lower than the positive reliability limit. For example, in an example embodiment, the lower voltage reliability limit is −10 volts whereas the upper voltage reliability limit is +30 volts. For some micromirror applications, a higher reset voltage may be desirable, but may be limited to −10 volts by the lower reliability limit.

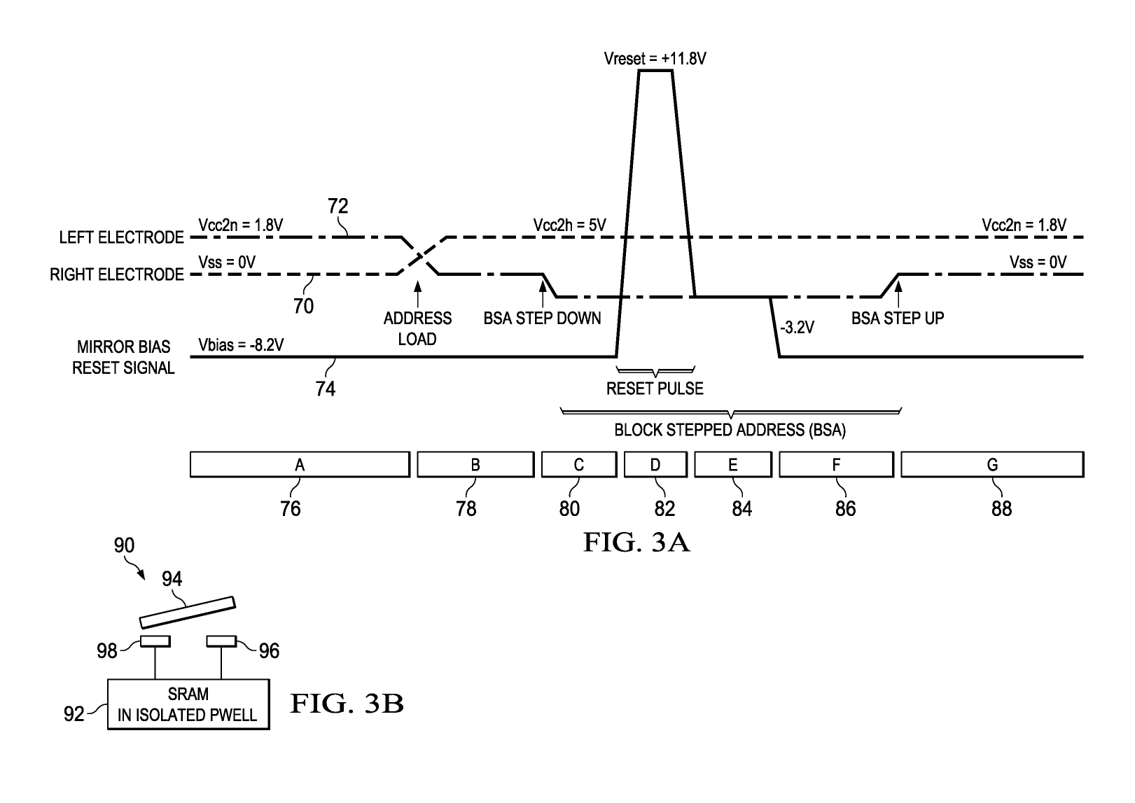

In an example embodiment termed “true inverted waveform” described in FIG. 3, the sign of voltages on the micromirror 94 and the electrodes, 96 and 98 are inverted. For example, the voltage of 10 volts (R1, C4) on the micromirror 64 is changed to −10 volts for the true inverted waveform”. In this example embodiment a +1.8 offset voltage is applied to raise the voltage on the micromirror from −10 volts (at the lower reliability limit) to a safer −8.2 volts (R2, C4). Likewise the voltage on the left electrode 98 is changed from 0 volts (R1, C5) to 1.8 volts (R2, C5) and the voltage on the right electrode is changed from 1.8 volts (R1, C6) to 0 volts (R2, C6) when the sign of the voltage is changed and the offset voltage of 1.8 volts is added. This same procedure (change the sign of the voltage for the conventional timing diagram and then add a 1.8 volt offset) is performed for each of the 7 steps in the timing diagram to obtain the true inverted waveform voltages. In the true inverted waveform example embodiment of FIG. 3, the difference voltages (R2, C7) and (R2, C8) are the same magnitude but of opposite sign when compared to the difference voltages (R1, C7) and (R1, C8) for a conventional voltage timing diagram of FIG. 2A. In fact the difference voltages for the true inverted waveform embodiment are the same magnitude but opposite sign when compared to the conventional waveform for each of the steps A, B, C, D, E, F, and G as may be seen in Table 1.

In the example true waveform embodiment the micromirror voltage never approaches the −10 V lower reliability limit. In addition because the reset voltage 82 is now positive, it may be raised to significantly higher voltages (up to approximately 25 volts if needed) without incurring reliability problems. This true inverted waveform embodiment provides designers with significantly more voltage margin with which to operate the micromirrors.

One disadvantage of the true inverted waveform embodiment may be that the BSA voltage in step C 80 is negative. Typically the left electrode 98 is coupled to one SRAM cell and the right electrode 96 is coupled to another SRAM cell in an SRAM array 92. To apply a negative voltage to one of the electrodes, 96 or 98, requires the SRAM be able to store negative voltages. For this to be possible in a conventional CMOS process the SRAM array may be formed in an isolated pwell. This may add additional cost to the processing flow if an isolated pwell is not already in the baseline CMOS process flow. To add an isolated pwell to a conventional baseline process flow may require the addition of deep nwell photoresist pattern and implant steps.

TABLE 1
MICROMIRROR OPERATION VOLTAGE OPTIONS

| | | | | | | | 7 | 8 |
|---|---|---|---|---|---|---|---|---|
| | | 2 | | | 5 | 6 | Delta Mirror | Delta Mirror |
| | 1 | STEP | 3 | 4 | Left | Right | to Left | to Right |
| ROW | STEP | NAME | Waveform | Mirror | Electrode | Electrode | Electrode | Electrode |
| 1 | A | Latch | Conventional | 10 | 0 | 1.8 | 10 | 8.2 |
| 2 | | Left | True Inverted | −8.2 | 1.8 | 0 | −10 | −8.2 |
| 3 | | | HV Inverted | −8.2 | 1.8 | 0 | −10 | −8.2 |
| 4 | B | Addr | Conventional | 10 | 1.8 | 0 | 8.2 | 10 |
| 5 | | Load | True Inverted | −8.2 | 0 | 1.8 | −8.2 | −10 |
| 6 | | | HV Inverted | −8.2 | 0 | 1.8 | −8.2 | −10 |
| 7 | C | BSA | Conventional | 10 | 5 | 0 | 5 | 10 |
| 8 | | Upset | True Inverted | −8.2 | −3.2 | 1.8 | −5 | −10 |
| 10 | | | HV Inverted | −8.2 | 0 | 5 | −8.2 | −13.2 |
| 11 | D | Reset | Conventional | −10 | 5 | 0 | −15 | −10 |
| 12 | | | True Inverted | 11.8 | −3.2 | 1.8 | 15 | 10 |
| 13 | | | HV Inverted | 15 | 0 | 5 | 15 | 10 |
| 14 | E | Bias | Conventional | 5 | 5 | 0 | 0 | 5 |
| 15 | | Off | True Inverted | −3.2 | −3.2 | 1.8 | 0 | −5 |
| 16 | | | HV Inverted | 0 | 0 | 5 | 0 | −5 |
| 17 | F | Bias | Conventional | 10 | 5 | 0 | 5 | 10 |
| 18 | | On | True Inverted | −8.2 | −3.2 | 1.8 | −5 | −10 |
| 20 | | | HV Inverted | −8.2 | 0 | 5 | −8.2 | −13.2 |
| 21 | G | Latch | Conventional | 10 | 1.8 | 0 | 8.2 | 10 |
| 22 | | Right | True Inverted | −8.2 | 0 | 1.8 | −8.2 | −10 |
| 23 | | | HV Inverted | −8.2 | 0 | 1.8 | −8.2 | −10 |

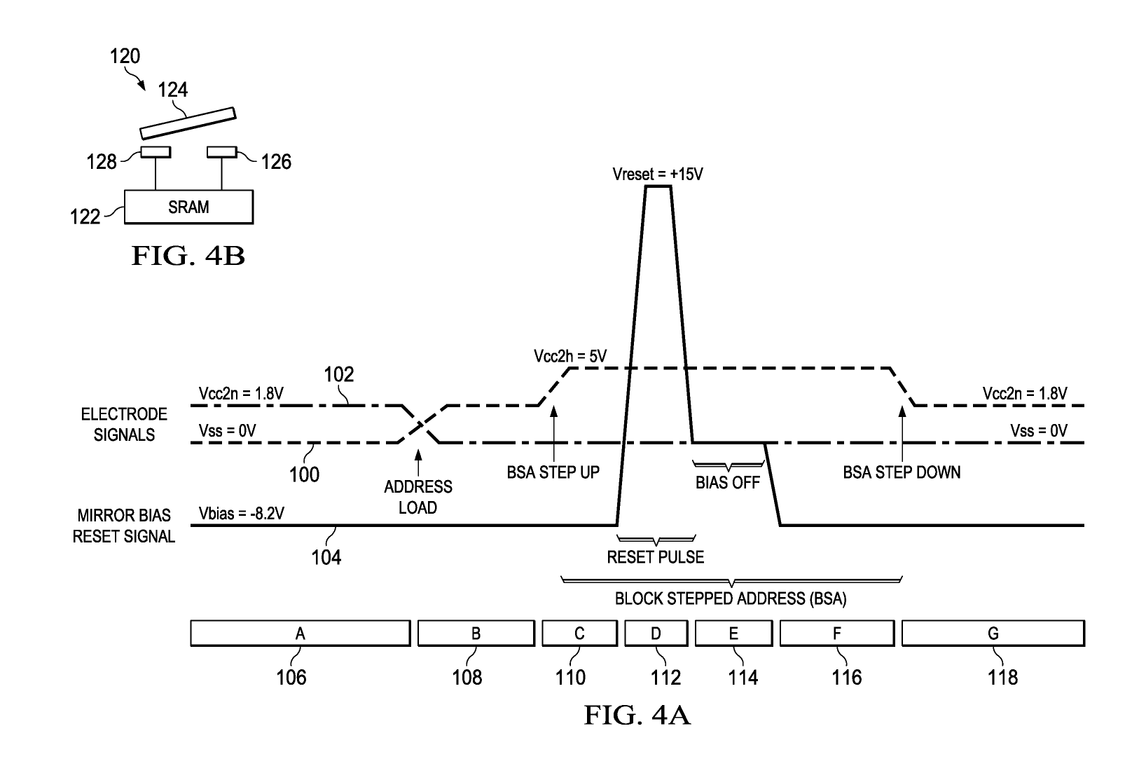

Another example embodiment termed “modified inverted waveform” is illustrated in FIG. 4. In this embodiment, instead of BSA stepping down −3.2 volts on the left electrode 3028 during steps C 3010, D 3012, E 3014, and F 3016 as in the true inverted waveform embodiment, the BSA voltage steps up an additional 3.2 volts on the right electrode 4028 during steps C 4010, D 4012, E 4014, and F 4016 in the modified inverted waveform embodiment. The reset pulse 4012 on the micromirror also steps up 3.2 volts from 11.8 volts (R12, C4) to 15 volts (R13, C4) in the modified inverted waveform embodiment. This embodiment does not require the SRAM 4030 to hold negative voltages and therefore avoids the cost of adding isolated pwells to a process flow.

The voltage differences between the micromirror 4024 and the electrodes 4026 and 4028 remain the same as for the true inverted waveform embodiment except for steps C 4010 and F 4016. In the modified inverted waveform embodiment, the difference voltage between the micromirror 124 and the electrodes 126 and 128 is 3.2 volts higher for both electrodes in step C, 110 (R10, C7 and R10, C8) and also in step F 116 (R20, C7 and R20, C8). For all other steps the voltages on the electrodes 126 and 128 for the modified inverted waveform embodiment in FIG. 4 are the same as for the electrodes 96 and 98 for the true inverted waveform embodiment in FIG. 3. Since the voltage is raised the same amount on both electrodes, 126 and 128, in steps C 110 and F 116 the electrostatic forces remain balanced.

The micromirror voltages and electrode voltages in the above embodiments are to illustrate the embodiments and are not limitations. These voltages may change depending upon the voltage capability and the voltage reliability limits of the baseline CMOS process flow. The inverted voltage embodiments enable a significantly larger range of micromirror operation voltages to be used with little or no change to the baseline CMOS process flow. This provides a wider range of voltages for the designers to utilize when operating the micromirrors without pushing the baseline CMOS reliability limits or adding manufacturing cost.

The embodiments described above may be implemented at low cost using a conventional CMOS process flow with 1.8 volt core transistors, 5 volt I/O transistors and with drain extended CMOS transistors (DEMOS) to switch voltages higher than 5 volts. A baseline CMOS process flow with DEMOS transistors for switching voltages higher than are used on the core CMOS transistors may also be used. For example, a core CMOS process flow with 1.8 volt core transistors may be used with the addition of DEMOS transistors to switch voltages higher than 1.8 volts. DEMOS transistors may be added to a core CMOS process flow with no additional process steps.

Those skilled in the art to which this invention relates will appreciate that many other embodiments and variations are possible within the scope of the claimed invention.

What is claimed is:

1. A method of actuating a digital micromirror device, comprising:
storing a logic state in a micromirror element including:
applying a negative voltage more negative than about −5 volts to the micromirror element,
applying a positive voltage less than about 5 volts to a first electrode, and
applying ground to a second electrode; and
switching from a first logic state to a second logic state with an inverted waveform, including:
applying ground to the first electrode,
applying a positive voltage less than 5 volts to the second electrode,
applying a negative BSA voltage to the first electrode,
applying a positive reset voltage pulse greater than about 10 volts, and
removing the negative BSA voltage, and applying the negative voltage to the micromirror element.

2. The method of claim 1, wherein the first electrode is coupled to a first SRAM cell in an SRAM array and the second electrode is coupled to a second SRAM cell in the SRAM array.

3. The method of claim 2, wherein the SRAM array is formed in an isolated p-type well.

4. The method of claim 1, wherein, during the step of storing a logic state, the negative voltage to the micromirror element is the range of −6 to −10 volts and the positive voltage to the first electrode is in the range of 1 to 5 volts.

5. The method of claim 4, wherein the negative voltage is approximately −8.2 volts and the positive voltage is approximately 1.8 volts.

6. The method of claim 4, wherein, during the step of switching, the positive voltage to the second electrode is in the range of 1 to 5 volts, the negative BSA voltage is in the range of −1 to −5 volts, the positive reset voltage is in the range of 10 to 25 volts and the negative voltage to the micromirror element is in the range of −6 to −10 volts.

7. The method of claim 6, wherein the positive voltage to the second electrode is approximately 1.8 volts, the negative BSA voltage is about −3.2 volts, the positive reset voltage is approximately 11.8 volts and the negative voltage to the micromirror is approximately −8.2 volts.

8. The method of claim 1, wherein the voltages which may be more negative than about 5 volts and more positive than about 5 volts are switched with drain extended CMOS transistors.

9. A method of operating an integrated circuit containing a micromirror element comprising:
storing a logic state in the micromirror element including:
applying a negative voltage more negative than about −5 volts to the micromirror element,
applying a positive voltage less than about 5 volts to a first electrode, and
applying ground to a second electrode; and
switching from a first logic state to a second logic state with a HV inverted waveform including:
applying ground to the first electrode,
applying a positive voltage less than 5 volts to the second electrode,
applying an additional positive BSA voltage to the second electrode,
applying a positive reset voltage pulse greater than about 10 volts, and
removing the additional positive BSA voltage, and applying the negative voltage to the micromirror.

10. The method of claim 9, wherein the first electrode is coupled to a first SRAM cell in an SRAM array, and the second electrode is coupled to a second SRAM cell in the SRAM array.

11. The method of claim 9, wherein, during the step of storing a logic state, the negative voltage to the micromirror is in the range of −6 to −10 volts and the positive voltage to the first electrode is in the range of 1 to 5 volts.

12. The method of claim 11, wherein the negative voltage is approximately −8.2 volts and the positive voltage may be approximately 1.8 volts.

13. The method of claim 9, wherein, during the step of switching, the positive voltage to the second electrode is in the range of 1 to 5 volts, the positive BSA voltage is in the range of 1 to 5 volts, the positive reset voltage is in the range of 10 to 25 volts, and the negative voltage to the micromirror is in the range of −6 to −10 volts.

14. The method of claim 13, wherein the positive voltage to the second electrode is approximately 1.8 volts, the positive BSA voltage is about +3.2 volts, the positive reset voltage is approximately 15 volts, and the negative voltage to the micromirror element is approximately −8.2 volts.

15. The method of claim 9, wherein the voltages more negative than about 5 volts and more positive than about 5 volts are switched with drain extended CMOS transistors.
